(19) United States
(12) Patent Application Publication
(10) Pub. No.: US 2013/0170896 A1
(43) Pub. Date: Jul. 4, 2013

(54) FIXING APPARATUS FOR FAN

(71) Applicants: WEI PANG, Shenzhen City (CN); JUN-HUI WANG, Shenzhen City (CN); KUN LI, Shenzhen City (CN)

(72) Inventors: WEI PANG, Shenzhen City (CN); JUN-HUI WANG, Shenzhen City (CN); KUN LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/463,825

(22) Filed: May 4, 2012

(30) Foreign Application Priority Data
Dec. 28, 2011 (CN) 201110446809.3

(51) Int. Cl. F16B 17/00

(52) U.S. Cl. 403/292

(57) ABSTRACT

A fixing apparatus includes an elongated base and a fixing member fixed to a bottom of a fan. The base defines a number of pairs of latching holes spaced in a longitudinal direction of the base. Two pairs of latching feet protrude from a bottom surface of the fixing member to extend through two pairs of the latching holes and engage with a bottom of the base. A hook extends from the fixing member to engage with a side of the base. The fixing member can fix the fan to different places of the base.

### BACKGROUND

1. Technical Field

The present disclosure relates to an apparatus for fixing a fan.

2. Description of Related Art

A fan can be mounted in a computer by a fixing apparatus. To meet heat dissipation demands of different motherboards, the fixing place of the fan should be adjusted, which often demands that the fixing apparatus be modified. Therefore, developing a flexible apparatus to meet different fan-mounting configurations would be desirable.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled, isometric view of an exemplary embodiment of a fixing apparatus together with a fan.

FIG. 2 is an exploded, isometric view of FIG. 1, wherein the fixing apparatus includes a fixing member.

FIG. 3 is an enlarged view of the fixing member of FIG. 2 from another perspective.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

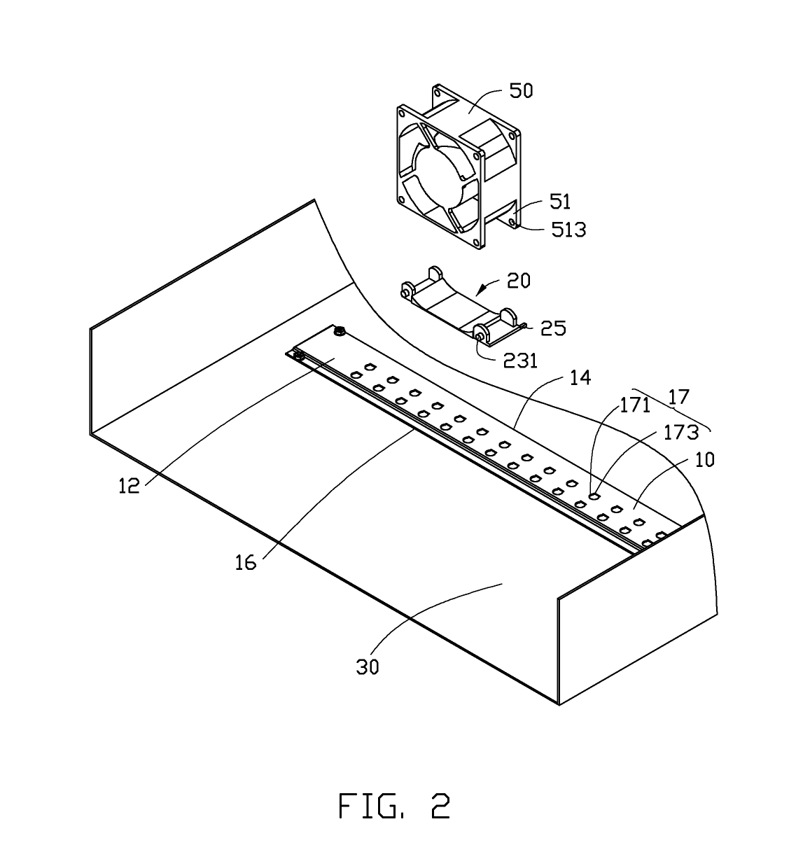

FIG. 2 shows an exemplary embodiment of a fixing apparatus which is provided to fix a fan 50. The fixing apparatus includes an elongated base 10, and a fixing member 20.

The base 10 includes an elongated fixing plate 12, a first lateral side portion 14 extending down from a side of the fixing plate 12, and an L-shaped second lateral side portion 16 extending down from an opposite side of the fixing plate 12. A plurality of screws is provided to fix opposite ends of the base 10 to a bottom plate 30 of a computer. The first and second lateral side portions 14 and 16 contact the bottom plate 30, and space the fixing plate 12 from the bottom plate 30. A plurality of pairs of latching holes 17 is defined in the fixing plate 12 and spaced in a longitudinal direction of the fixing plate 12. Each pair of latching holes 17 are spaced in a widthwise direction of the fixing plate 12. Each latching hole 17 includes a first hole 171 adjacent to the second lateral side portion 16, and a second hole 173 adjacent to the first lateral side portion 14. A width of the second hole 173 in the longitudinal direction of the fixing plate 12 is less than a width of the first hole 171 in the longitudinal direction of the fixing plate 12.

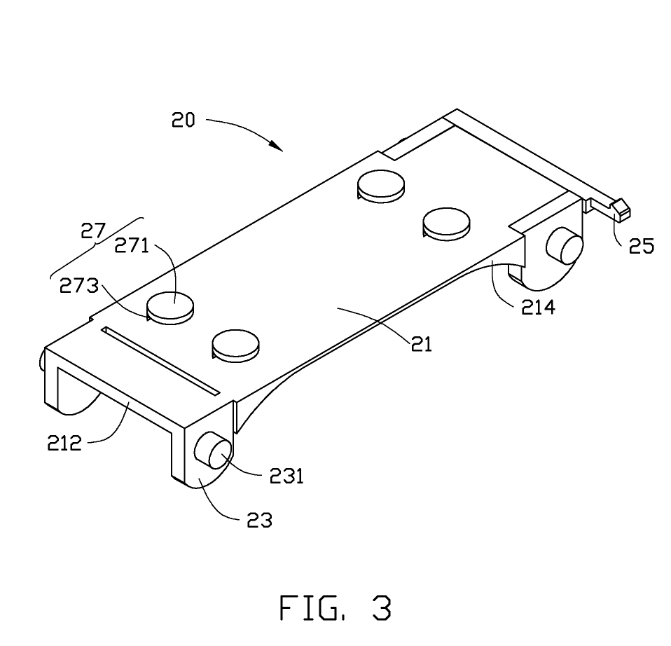

Referring to FIG. 3, the fixing member 20 includes a substantially rectangular bottom wall 21. The bottom wall 12 includes two opposite ends 212 and two opposite sides 214. Two resilient tabs 23 respectively extend up from opposite ends of each side 214. A pole 231 protrudes from an outer surface of each tab 23. A downward-pointing hook 25 extends out from one of the sides 214. Two pairs of latching feet 27 are formed on the bottom surface of the bottom wall 21, and spaced in a longitudinal direction of the bottom wall 21. Each pair of latching feet 27 are spaced in a widthwise direction of the bottom wall 21. Each latching feet 27 includes a latching portion 271, and a connecting portion 273 connected between the bottom wall 21 and an end the latching portion 271 away from the side 214 having the hook 25.

The fan 50 includes two opposite sidewalls 51. Two fixing holes 513 are respectively defined in opposite ends of the bottom of each sidewall 51.

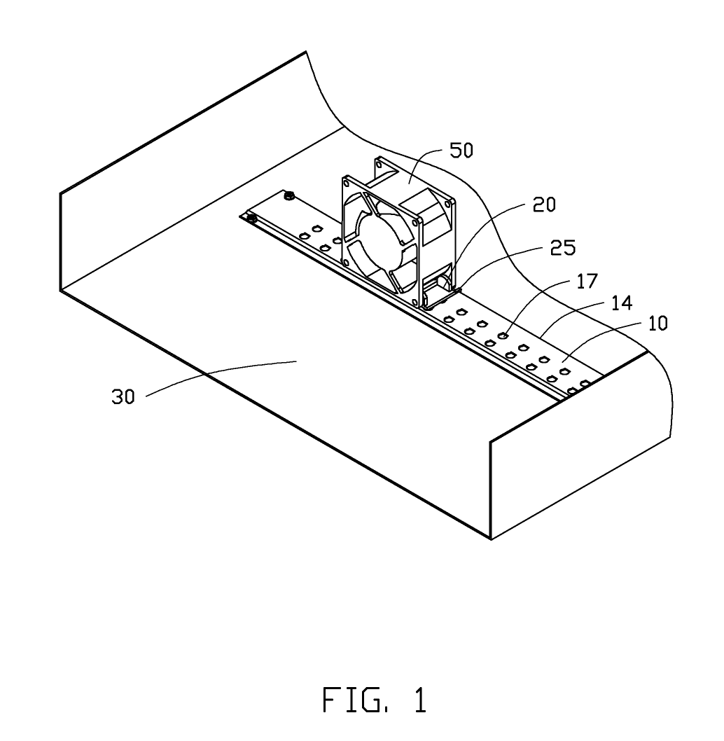

Referring to FIG. 1, in assembly, the tabs 23 are deformed to be received in a space between bottoms of the sidewalls 51, to allow the poles 231 to respectively align with the fixing holes 513 of the fixing walls 51. The tabs 23 are released and restored to allow the poles 231 to respectively engage in the corresponding fixing holes 513. Thereby, the fixing member 20 is mounted to the bottom of the fan 50. According to heat dissipation demand, the fan 50 is placed at a desired place on the base 10 extending the latching portions 271 through corresponding first holes 171. The fan 50 is slid towards the first lateral side portion 14, until the connecting portions 273 engage in the corresponding second holes 173 and abut against portions of the fixing plate 12 bounding the second holes 173 adjacent to the first lateral side portion 14. The fixing plate 12 blocks the connecting portions 273, preventing the fan 50 from sliding further towards the first lateral side portion 14. The latching portions 271 engage with the bottom surface of the fixing plate 12. The hook 25 engages with the first lateral side portion 14, preventing the fan 50 moving towards the second lateral side portion 16. Thereby, the fan 50 is fixed to the base 10.

Because there is a plurality of spaced latching holes 17 defined in the base 10 in the longitudinal direction of the base 10, the fixing member 20 can fix the fan 50 in different places on the base 10.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A fixing apparatus for a fan, comprising:
an elongated base defining a plurality of pairs of latching holes spaced in a longitudinal direction of the base; and
a fixing member to be fixed to a bottom of the fan, two pairs of latching feet protruding from a bottom surface of the fixing member to extend through two pairs of the latching holes and engage with a bottom of the base, and a hook extending from the fixing member to engage with a side of the base.

2. The fixing apparatus of claim 1, wherein the fixing member comprises a bottom wall forming two opposite sides, the hook extends outwards from one of the sides, the pairs of latching feet protrude from a bottom surface of the bottom wall, each of the latching feet comprises a latching portion, and a connecting portion connected between the bottom surface and an end the latching portion adjacent to the other one of the sides.

3. The fixing apparatus of claim 2, wherein the base comprises an elongated fixing plate, a first lateral side portion and a second lateral side portion are respectively formed on opposite sides of the fixing plate, the pairs of latching holes are defined in the fixing plate and spaced in a longitudinal direction of the fixing plate, the connecting portion extend through the corresponding latching holes and slides along a direction from the second lateral side portion to the first lateral side portion to engage with portions of the bottom of the base bounding the corresponding latching holes adjacent to the first lateral side portion, to prevent the fixing member from further moving towards the first lateral side portion, the hook engages with the first lateral side portion, to prevent the fixing member from moving towards the second lateral side portion.

4. The fixing apparatus of claim 3, wherein each latching hole comprises a first hole adjacent to the second lateral side portion, and a second hole adjacent to the first lateral side portion, a width of the second hole in the longitudinal direction of the fixing plate is less than a width of the first hole in the longitudinal direction of the fixing plate.

5. The fixing apparatus of claim 3, wherein each pair of latching holes are spaced in a widthwise direction of the fixing plate, and each pair of latching feet are spaced in a widthwise direction of the bottom wall.

6. The fixing apparatus of claim 3, wherein the base is mounted on a bottom plate of a computer, the first and second lateral side portions contact the bottom plate, and space the fixing plate from the bottom plate.

7. The fixing apparatus of claim 2, wherein two resilient tabs respectively extend up from opposite ends of each side of the bottom wall of the fixing member, and a pole protrudes from an outer surface of each tab, for engaging with the fan.
